(19) United States
(12) Patent Application Publication
(10) Pub. No.: US 2023/0211296 A1
(43) Pub. Date: Jul. 6, 2023

(54) POROUS MEMBRANE OF POLYTETRAFLUOROETHYLENE AND/OR MODIFIED POLYTETRAFLUOROETHYLENE HAVING HIGH STRENGTH AND SMALL PORE DIAMETER

(71) Applicant: CHEMOURS-MITSUI FLUOROPRODUCTS CO., LTD, Tokyo (JP)

(72) Inventors: KOHEI MIYAMAE, SHIZUOKA (JP); SHUNICHI SHIMATANI, SHIZUOKA (JP); KAZUO KONABE, SHIZUOKA (JP)

(73) Assignee: CHEMOURS-MITSUI FLUOROPRODUCTS CO., LTD., TOKYO (JP)

(21) Appl. No.: 17/923,966

(22) PCT Filed: May 5, 2021
(86) PCT No.: PCT/US2021/030873

§ 371 Date: Nov. 8, 2022

(30) Foreign Application Priority Data
May 8, 2020 (JP) 2020-082449
Feb. 26, 2021 (JP) 2021-029375

(51) Int. Cl. B01D 71/36; B01D 69/02; B01D 69/06; B01D 67/00

(52) U.S. Cl. CPC B01D 71/36; B01D 69/02; B01D 69/06; B01D 67/0027; B01D 67/00091; B01D 67/0083; B01D 2325/24; B01D 2325/04; B01D 2325/22; B01D 2323/081; B01D 2323/50; B01D 2323/219; B01D 2323/42

(57) ABSTRACT

Provided is a porous membrane including polytetrafluoroethylene and/or modified polytetrafluoroethylene having a small pore diameter, thin film thickness, high porosity, and high strength; and a method for manufacturing the same. The porous membrane including polytetrafluoroethylene and/or modified polytetrafluoroethylenehas bubble point of isopropyl alcohol according to JIS K3832 of 600 kPa or more, and tensile strength according to JIS K6251 of 90 MPa or more.

### CROSS-REFERENCE TO RELATED APPLICATIONS

This application claims the benefit of Japanese Patent Application No. JP 2020-82449, filed May 8, 2020, and Japanese Patent Application No. JP 2021-29375, filed Feb. 26, 2021, which are incorporated by reference herein in their entirety.

### TECHNICAL FIELD

The present invention relates to a porous membrane of polytetrafluoroethylene and/or modified polytetrafluoroethylene having a thin film thickness, small pore diameter, high porosity, resistance to tearing in the stretching direction and the direction orthogonal to the stretching direction, and high strength; and a method for manufacturing the same.

### BACKGROUND TECHNOLOGY

Polytetrafluoroethylene (PTFE) containing a copolymer with trace amounts of monomers has been utilized in a variety of fields due to its excellent heat resistance, chemical resistance, water repellency, weather resistance, and low dielectric constant. Many PTFE porous membranes with various properties and manufacturing methods thereof have been invented to provide easier porosification of the PTFE by stretching.

PTFE porous membranes have high permeability as well as high water repellency and are therefore used in applications such as clothing having waterproof permeability, vent filters for adjusting the internal pressure of automobile parts, and waterproof sound transmitting membranes of communication equipment.

The waterproofing performance is indicated by a numerical value from water resistant pressure testing. For example, a membrane used in a 100 m waterproof cell phone, etc. requires a water resistant pressure of 1 MPa. However, a membrane having a water resistant pressure of 1 MPa must have a pore diameter of tens of nanometers or less.

Moreover, because the waterproof sound transmitting membrane must not attenuate or deteriorate the signal, such as speech voice, via the membrane, the membrane is required to have a small pore diameter, thin film thickness, and high porosity, that is, a low surface density (i.e., the weight of the membrane per unit area) in order to prevent attenuation of the signal and/or the addition of incidental sound due to inherent vibration of the porous membrane itself. The surface density is determined from the porosity and film thickness. For example, if the film thickness is 30 um and the porosity is 70%, the surface density is approximately 20 g/m². In the application of waterproof sound transmission, this surface density is 10 g/m² or less, preferably several g/m², with high strength also required.

In dustproof applications, PTFE porous membranes are used for filters for air cleaners or cleaners, bag filters for dust collection such as garbage incinerators, and air filters for clean rooms for manufacturing semiconductors.

In addition, due to the pure nature of the PTFE, that is, because of the presence of little eluate, PTFE porous membranes have been used instead of conventional ultrafiltration membranes as the final filter in the manufacture of ultrapure water.

In addition, because PTFE porous membranes have excellent chemical resistance, they are also used in applications such as filtration applications including etching solutions of circuit boards in corrosive liquids, organic solvents, or semiconductor manufacturing applications, as well as applications such as the collection of valuable substances in etching solutions.

In semiconductor manufacturing applications, there has been a recent increase in the degree of integration of the circuit. Therefore, PTFE porous membranes (having nano scale pore diameters) capable of removing nano scale fine particles in the etching solution are required because the presence of nano scale fine particles in the etching solution allows the fine particles to remain on the wiring of the integrated circuit and causes a decrease in yield in the manufacture thereof. Unfortunately, it has been difficult to obtain PTFE porous membranes (having nano scale pore diameters) which have a thin film thickness and strength to resist the filtration pressure or filtration operation without reducing the amount of permeation.

In general, the PTFE porous membrane may be used in its own intended use, but many are used in combination with a substrate and integrated with the substrate. The base material in this case is a nonwoven fabric, cloth, mesh, etc. The base material has no function such as filtration, filter performance, waterproof dust-proof, etc., but is used as a role for holding the porous film. When a PTFE porous membrane is used for the purpose of filtration, dust collection, collection and dust prevention, it is necessary to reduce the film thickness of the PTFE porous film in order to efficiently perform filtration, dust collection, collection and dust prevention. In particular, it is desirable that the thickness of the film is reduced in the composite with the base material. For example, although a PTFE porous membrane having a thickness of 30 to 50 μm is generally commercially available for liquid filtration applications, the thickness of the PTFE porous membrane is preferably thinner, more preferably 30 μm or less, more preferably 20 μm or less, and more preferably 10 μm or less. The film thickness of the PTFE porous film is preferably 30 μm or less, more preferably 20 μm or less, and the particles cannot be collected efficiently when the thickness of the air filter or bag filter is not more than 10 μm. In this case, when the film thickness of the PTFE porous film becomes thin, the strength is reduced, handling is difficult, and even when the PTFE porous film is combined with the base material, the desired purpose cannot be achieved because of insufficient strength.

Generally, PTFE porous membranes are often manufactured in the following steps: 1.) A PTFE and an auxiliary agent (hydrocarbon based solvent, etc.) are mixed.; 2.) The ratio (RR) of the cylinder cross sectional area/outlet cross sectional area is increased, after which shear (shear force) is applied to the PTFE by extrusion molding to obtain a sheet shaped or bead shaped extrudate during fibrillation.; 3.) After the obtained extrudate is appropriately rolled into a sheet shape using a rolling machine (roll), etc., the hydrocarbon based solvent is evaporated and removed.; 4.) The obtained sheet shaped product is stretched in the extrusion direction (hereinafter, also referred to as the MD) and in the direction (hereinafter, also referred to as the CD) perpendicular to the extrusion direction, after which a PTFE porous membrane is obtained by sintering at a temperature of the melting point of the PTFE or higher (for example, 342 to 343° C. or higher).

However, with such a general method, it is difficult to obtain PTFE porous membranes having small pore diameters. Further, in the porous membrane of the thin membrane, problems may arise in the process of manufacturing the membrane or tearing of the porous membrane under the use conditions. The cause of tearing of the porous membrane is considered to be in the rolling step in which the thickness is adjusted using a roll. When the thickness of the porous membrane in the rolling step is reduced in order to ensure permeability of the porous membrane, tearing occurs during stretching. In addition, even when the stretching ratio in the MD and CD is adjusted, the obtained porous membrane tends to have higher tensile strength in the MD and lower tensile strength in the CD. A large tensile strength ratio in the MD to CD is considered to be one of the causes of forming an easily torn porous membrane.

In Patent Document 1, a PTFE dispersion is cast on an aluminum foil and dried to produce a microporous fluororesin membrane (containing PTFE as the main component), which is laminated with a commercially available PTFE porous membrane having a small pore diameter, the aluminum foil is subsequently dissolved and removed using an acid, etc., and stretched at a low ratio, after which the PTFE porous membrane having a small pore diameter is integrated as a filter and used in semiconductor applications.

Moreover, in Patent Document 2, a PTFE coating membrane is formed by immersing a polyimide film in a PTFE dispersion, a PTFE membrane is obtained by repeating the drying/sintering step, the PTFE membrane is peeled from the polyimide film, and the peeled PTFE membrane is sequentially stretched in the CD and MD. The porous membrane obtained by this method does not attenuate or deteriorate the signal and is used as a thin PTFE membrane (having a small surface density) in the application of a waterproof sound transmitting membrane.

In Patent Document 3, a stretched film with high filtration efficiency is produced which has an asymmetric structure (in which the average pore diameter in the thickness direction is continuously reduced and the average pore diameter of the heating surface is 0.05 μm to 10 μm) and is used for the fine filtration of gases, liquids, etc. by sequentially stretching and thermally fixing a partially sintered film (wherein, in the process of manufacturing a PTFE porous membrane, a temperature gradient is formed in the thickness direction of the film by heating one side of the film prior to stretching) in the extrusion direction (MD) and the direction (CD) perpendicular to the extrusion direction.

However, dissolution by acid in the removal step of the aluminum foil of Patent Document 1 and peeling of the PTFE membrane from the polyimide film in Patent Document 2 are not easy, with the PTFE membrane breaking, etc. Moreover, Patent Document 3 also requires complex steps. While these conventionally known techniques are effective in limited applications, problems remain such as the increased surface density of the membrane or lack of membrane strength in other applications, making it difficult to obtain a PTFE porous membrane with all properties consisting of a small pore diameter, thin film thickness, high porosity, and high strength.

### Patent Documents

Patent Document 1: WO 2013/084858
Patent Document 2: JP 6178034 B
Patent Document 3: JP 4850814 B
Patent Document 4: WO 2007/119829
Patent Document 5: JP 5054007 B
Patent Document 6: JP 2010-99889 A

### SUMMARY OF THE INVENTION

### Problem to be Resolved by the Invention

The problem of the present invention is solved by providing: a novel porous membrane including polytetrafluoroethylene and/or polytetrafluoroethylene having a thin film thickness, small pore diameter, and high porosity, wherein the difference in the tensile strength between the MD and CD is small, such that the ratio of both tensile strength is close to 1 and the porous membrane has high strength; and/or a method for manufacturing a porous membrane including polytetrafluoroethylene and/or modified polytetrafluoroethylene in which tearing of the porous membrane is prevented during the manufacturing process. The present invention provides a porous membrane comprising polytetrafluoroethylene and/or modified polytetrafluoroethylene having a thin film thickness and strong strength.

### Means for Resolving Problems

The present invention provides a porous membrane including polytetrafluoroethylene and/or modified polytetrafluoroethylene, wherein the bubble point with an isopropyl alcohol (IPA) according to JIS K3832 is 600 kPa or more, the tensile strength according to JIS K6251 is 90 MPa or more, and the tensile strength ratio in the extrusion direction (MD) to the direction (CD) perpendicular to the extrusion direction is 0.5 to 2.0.

The present invention also provides a porous membrane, wherein the heat of fusion of the porous membrane including polytetrafluoroethylene and/or modified polytetrafluoroethylene at 360 to 385° C. (when the temperature is increased to 400° C. at a rate of 10° C./min and determined using a differential scanning calorimeter) is 5.0 J/g or more.

Note that in the present application, the heat of fusion is determined using a differential scanning calorimeter by subtracting the baseline within a certain temperature range. For example, the heat of fusion determined (J/g) at 300 to 360° C., or 360° C. to 385° C.

A preferred aspect of the present invention is a porous membrane, wherein the temperature is first increased to 400° C. at a rate of 10° C./min (1st. RUN), then cooled to 200° C. at a rate of 10° C./min, after which the temperature is increased a second time to 400° C. at a rate of 10° C./min (2nd. RUN) in order to obtain a DSC curve, and wherein at 290 to 335° C. in the second temperature increase (2nd. RUN) determined using the DSC curve, the crystal heat of fusion (J/g) (H4) of the porous membrane including polytetrafluoroethylene and/or modified polytetrafluoroethylene determined using a differential scanning calorimeter is 20 J/g or less.

A preferred aspect of the present invention is a porous membrane including polytetrafluoroethylene and/or modified polytetrafluoroethylene, wherein the degree of sintering (S) of the porous membrane represented by Equation 1 is 0.8 or more.

Degree of sintering(S)=(H1-H3)/(H1-H4) Equation 1

Wherein:

H1 is the heat of fusion (J/g) of the polytetrafluoroethylene and/or modified polytetrafluoroethylene having no heating history at 300° C. and higher used to make the porous membrane, measured from the DSC curve over a temperature range of 300 to 360° C. using a differential scanning calorimeter (DSC), wherein the sample temperature is increased at a rate of 10° C./min,

H3 is the heat of fusion (J/g) of the polytetrafluoroethylene and/or modified polytetrafluoroethylene porous membrane for the first melt (1st RUN), measured from the DSC curve over a temperature range of 300 to 360° C. using a differential scanning calorimeter, wherein the sample temperature is increased at a rate of 10° C./min, and

H4 is the heat of fusion (J/g) of the polytetrafluoroethylene and/or modified polytetrafluoroethylene porous membrane for the second melt (2nd RUN), measured from the DSC curve over a temperature range of 290 to 335° C. using a differential scanning calorimeter, wherein the sample temperature is increased to 400° C. at a rate of 10° C./min (first melt), then the sample is cooled to 200° C. at a rate of 10° C./min, then the sample temperature is increased to 400° C. at a rate of 10° C./min (second melt) to generate a DSC curve from which H4 is determined.

A preferred aspect of the present invention is a porous membrane including polytetrafluoroethylene and/or modified polytetrafluoroethylene having a porosity of 70% or more.

A preferred aspect of the present invention is a porous membrane including polytetrafluoroethylene and/or modified polytetrafluoroethylene having a film thickness of 30 μm or less.

A preferred aspect of the present invention is a porous membrane including polytetrafluoroethylene and/or modified polytetrafluoroethylene obtained from polytetrafluoroethylene, which has a standard specific gravity of 2.15 or less and satisfies Equation 2.

H1-H2>12 Equation 2

### Wherein:

H1 is as defined earlier herein,

H2 is the heat of fusion (J/g) of the polytetrafluoroethylene and/or modified polytetrafluoroethylene formed into a stretched membrane product, the polytetrafluoroethylene and/or modified polytetrafluoroethylene having no heating history at 300° C. and higher,

wherein H2 is measured from the DSC curve over a temperature range of 300 to 360° C. using a differential scanning calorimeter (DSC), wherein the sample temperature is increased to 400° C. at a rate of 10° C./min, and,

wherein the formed stretched membrane product is obtained by mixing 100 g of polytetrafluoroethylene and/or modified polytetrafluoroethylene with about 28.7 ml of naptha having a boiling point of about 150-180° C. for about 3 minutes and then left to stand at about 25° C. for about 2 hours, and then using an extruder to ram extrude a bead-shaped extrudate from the fluoropolymer and naptha mixture, the extrudate being formed at a ratio (RR) of the extruder cylinder cross sectional area to outlet cross sectional area of about 100 and a ram extrusion rate of about 0.5 m/min, and a temperature of about 25° C., resulting in formation of the bead-shaped extrudate, which is then dried at about 25° C. for about 1.5 hours and then dried further at about 150° C. for about 2 hours, following which the dried bead shaped extrudate is then stretched 25-fold in the extrusion direction at a temperature of about 300° C. and a stretching rate of about 100%/second and then cooled to room temperature resulting in the formed and stretched membrane product.

A preferred aspect of the present invention is a porous membrane, wherein the modified polytetrafluoroethylene is a copolymer including: tetrafluoroethylene; and at least one monomer selected from hexafluoropropylene, perfluoro(alkylvinyl ether), fluoroalkyl ethylene, chlorotrifluoroethylene, vinylidene fluoride, vinyl fluoride, and ethylene, or a mixture thereof. At least one such monomer in the copolymer is 0.005 to 1 mol % of the total copolymer.

The present invention also provides a method for manufacturing a porous membrane including polytetrafluoroethylene and/or modified polytetrafluoroethylene, the method including: adding and mixing a hydrocarbon based solvent having a boiling point of 150 to 290° C. into the specific polytetrafluoroethylene; extruding the mixture at an RR of 35 to 120 using an extruder to obtain a sheet shaped or bead shaped extrudate; rolling the extrudate in the extrusion direction (MD) and the direction (CD) perpendicular to the extrusion direction at least once together so as to obtain a rolled product having a thickness of 400 μm or less; heating the rolled product to 150° C. or higher in order to evaporate and remove the hydrocarbon based solvent; and thereafter sequentially biaxially stretching the rolled product in the MD and CD to obtain a porous membrane; then sintering the porous membrane at a temperature no lower than the melting point of polytetrafluoroethylene.

In addition, a preferred aspect of the present invention is a method for manufacturing a porous membrane including polytetrafluoroethylene and/or modified polytetrafluoroethylene, wherein the rolled product is sequentially biaxially stretched five-fold or higher in the MD and five-fold or higher in the CD such that the strain rate represented by Equation 3 in the MD is 20%/sec or higher.

Strain rate (%/sec)=(Vex-Vin)/Lx100 Equation 3

### Wherein:

a) In the case of continuous stretching:
   Vex is the rate (mm/sec) of the outlet of the vertical (extrusion direction) stretching apparatus,
   Vin is the rate (mm/sec) of the inlet of the vertical (extrusion direction) stretching apparatus, and
   L is the inter-stretching distance (mm) (distance between two sets of rolls); and
b) in the case of non-continuous stretching:
   (Vex-Vin) is the stretching rate (mm/sec) of the biaxial stretching apparatus, and
   Is the inter-stretching distance (mm) (value obtained by subtracting the size of the pre-stretched sheet shaped rolled product from the size of the stretched sheet material).

### Effect of the Invention

The PTFE porous membrane including polytetrafluoroethylene and/or modified polytetrafluoroethylene according to the present invention has a thin film thickness, small pore diameter, high porosity, and small difference in the tensile strength between the MD and CD, thereby giving it a tensile strength ratio of close to 1 as well as high strength. Moreover, using the manufacturing method of the present invention, the porous membrane can be prevented from tearing due to stretching in the manufacturing process.

The present invention can be used in waterproof sound transmitting applications for communication apparatus, automotive vent filters which require high water resistance, dust proofing applications such as dust collecting bag filters and air filters, and filtration applications such as etching solutions of circuit boards in corrosive liquids, organic solvents, or semiconductor manufacturing applications, as well as applications such as the collection of valuable substances in etching solutions. The present invention also allows for the manufacture of a PTFE porous membrane without requiring complex steps.

### BRIEF DESCRIPTION OF THE DRAWINGS

FIG. 1 is a schematic view of a rolling method in the CD employed in the present invention.

FIG. 2 is a schematic view of a continuous stretching apparatus and a discontinuous stretching apparatus.

FIG. 3 is a DSC curve determined using a differential scanning calorimeter of PTFE of Example 1.

FIG. 4 is a DSC curve determined using a differential scanning calorimeter of a PTFE porous membrane of Example 1.

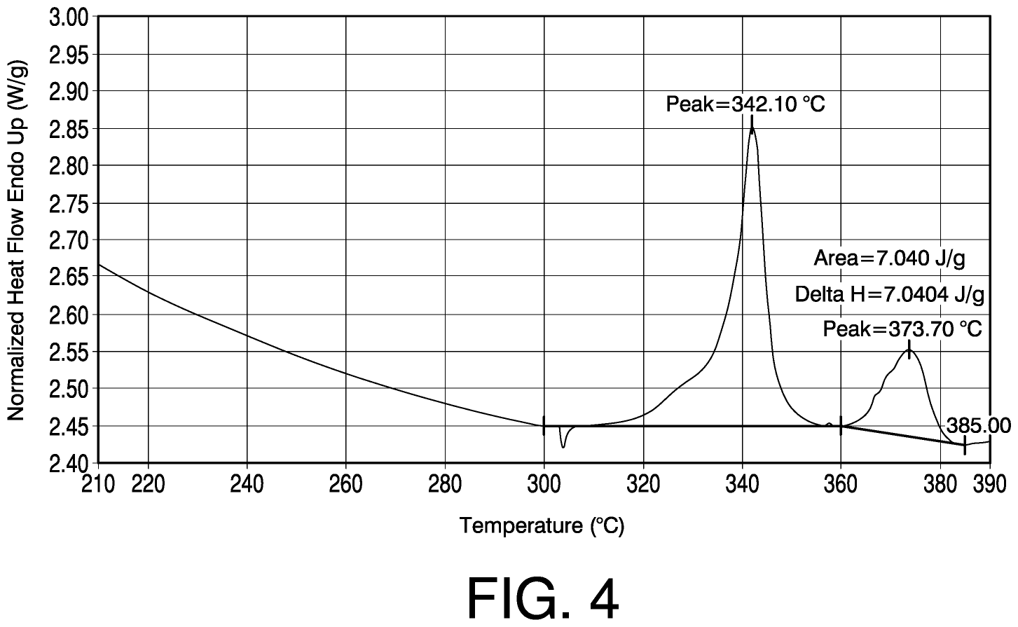

FIG. 5 is an electron microphotograph (magnification: 5000 times) of the surface of the PTFE porous membrane of Example 1.

Description of Symbols Used in the Drawings
1 and 2: One set of rolls on the inlet side of the biaxial stretching machine
3 and 4: One set of rolls on the outlet side of the biaxial stretching machine
5: Heating furnace
6: Sheet shaped rolled product
7: Longitudinal (extrusion direction) stretching membrane
8: Fixed chuck of the biaxial stretching machine
9: Sheet shaped rolled product
10: Biaxial stretched membrane (PTFE porous membrane)

### DESCRIPTION OF THE PREFERRED EMBODIMENTS

The bubble point with isopropyl alcohol (IPA) according to JIS K3832 of the present invention is 600 kPa or more, preferably 700 kPa or more, and more preferably 750 kPa or more. A bubble point of 600 kPa or more indicates that the pore diameter of the PTFE porous membrane is a small pore diameter capable of removing nano order fine particles. In general, the maximum pore diameter of the PTFE porous membrane is calculated using the bubble point and Equation 4.

Maximum pore diameter(nm) of the PTFE porous membrane=4×T×cosθ/P×10⁹ Equation 4

### Wherein:

T: IPA surface tension (Pa·m)

θ: contact angle (θ=0) between the IPA and porous membrane

P: bubble point pressure (Pa)

If the bubble point is 600 kPa, the maximum pore diameter of the PTFE porous membrane according to the present invention calculated in Equation 4 is approximately 130 nm. However, because there are a large number of pore diameters of 130 nm or less in the PTFE porous membrane, it is possible to capture particles of tens of nanometers upon filtration of the liquid. In general, when the bubble point is less than 400 kPa, the removal of nanoparticles of the nano order is difficult and waterproofing also deteriorates, which is not preferable.

Because the PTFE porous membrane according to the present invention has a bubble point of 600 kPa or more, it is a porous membrane which has a small pore diameter as well as high strength and does not leak water without tearing even at a water pressure close to 100 m in the applications of vent filters or waterproof sound transmission.

The tensile strength in accordance with JIS K6251 according to the present invention is the value (MPa) obtained by dividing the tensile stress by the cross sectional area and is therefore not affected by the film thickness, wherein a PTFE porous membrane having a different film thickness can be compared at the tensile strength of its own value. The tensile strength of the PTFE porous membrane according to the present invention is preferably 90 MPa or more, more preferably 100 MPa or more. If the tensile strength is 90 MPa or more, the PTFE porous membrane has sufficient strength and preferably can resist thinning of the PTFE porous membrane and the filtration pressure and filtration operation of the liquid or gas, in addition to increasing the amount of permeation. If the tensile strength is less than 90 MPa, in addition to the difficulty in thinning the PTFE porous membrane, in the step of bonding the PTFE porous membrane to a substrate in the manufacture of a filtration membrane or processing the PTFE porous membrane into a pleat shape with a substrate, a thinned PTFE porous membrane is not preferable because it has insufficient strength and tears.

Moreover, although Patent Document 2 describes that the tensile strength is 30 MPa or more in the application of the waterproof sound transmitting membrane, the PTFE porous membrane according to the present invention has a tensile strength of 90 MPa or more and can be a thinner membrane, consequently making it possible to further improve the sound transmitting properties. In addition, welding with a waterproof sound transmitting member described in the aforementioned patent is also possible.

The tensile strength of the PTFE porous membrane correlates to the sintering conditions of PTFE. If the degree of sintering (S) calculated by the abovementioned Equation 1 is 0.8 or more, a PTFE porous membrane having a high bubble point and high tensile strength is obtained. In contrast, when the degree of sintering (S) is too high, because the PTFE fibril structure caused by stretching is broken and the pore diameter of the PTFE porous membrane increases, the degree of sintering (S) is preferably less than 0.98.

The degree of sintering (S) is generally understood by a person skilled in the art; however, a particular degree of sintering (S) of the present invention allows for a PTFE porous membrane with both high tensile strength and a small pore diameter.

The tensile strength ratio of the PTFE porous membrane in the extrusion direction (MD) to the tensile strength in the direction (CD) perpendicular to the extrusion direction is preferably within the range of 0.5 to 2.0. The tensile strength ratio is preferably 0.5 to 1.8, more preferably 0.6 to 1.5. In general, the difference in the tensile strength of the PTFE porous membrane between the MD and CD is preferably small and the ratio is preferably close to 1 because it becomes difficult to tear the porous membrane when an external force is applied to the porous membrane.

The PTFE porous membrane according to the present invention preferably has a heat of fusion of 5.0 J/g or more at 360 to 385° C., determined using a differential scanning calorimeter (when the temperature is increased to 400° C. at a rate of 10° C./min). It is more preferably 6.0 J/g or more. If the heat of fusion of the PTFE porous membrane at 360 to 385° C. (when the temperature is increased to 400° C. at a rate of 10° C./min) is less than 5.0 J/g, a tensile strength of 90 MPa or higher cannot be obtained, resulting in a membrane with inferior tensile strength.

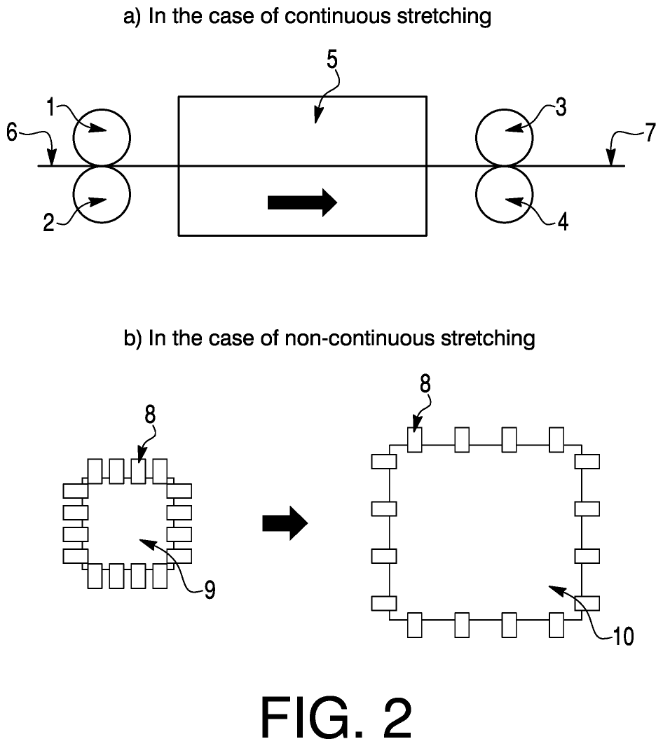

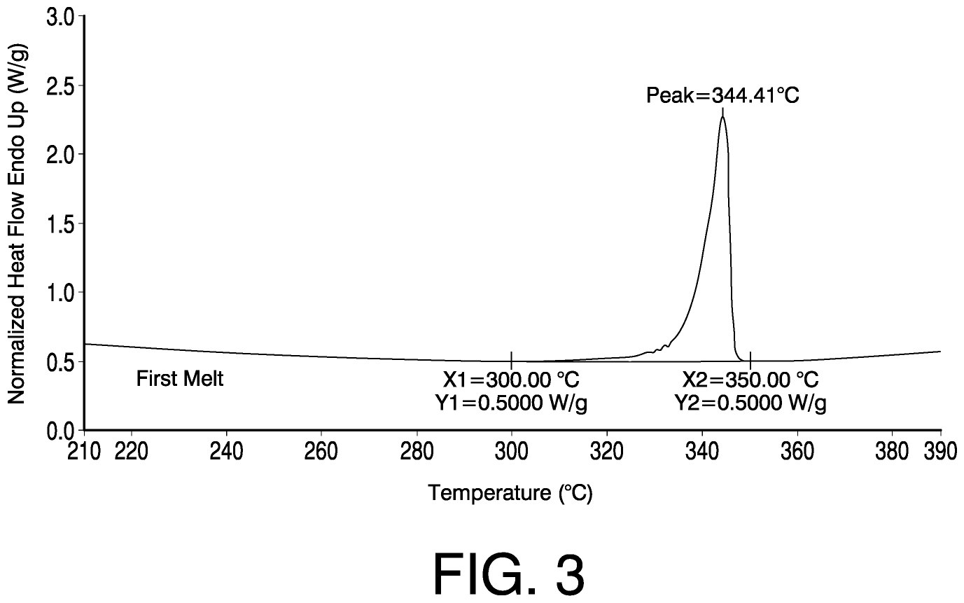

In the PTFE porous membrane, the peak of heat absorption within a temperature range of 300° C. or higher by a differential scanning calorimeter is generally the endothermic peak at 300 to 360° C. (derived from unsintered crystals formed during PTFE polymerization) and the endothermic peak at 327° C. (derived from crystals obtained by melting the crystals of the unsintered PTFE at the melting point temperature or higher, then cooling and recrystallizing them). In contrast, the PTFE porous membrane according to the present invention has an endothermic peak observed at 360 to 385° C. other than the two endothermic peaks. This endothermic peak at 360 to 385° C. is not expressed in the PTFE itself used in the present invention, a sheet shaped or bead shaped extrudate of the PTFE, or a sheet shaped rolled product in which the extrudate is rolled (see FIG. 2), but is expressed for the first time in the stretched membrane (PTFE porous membrane) obtained by stretching the sheet shaped rolled product (see FIG. 3). Further, because the endothermic peak does not disappear even when the PTFE porous membrane is sintered at 385° C., it is considered to be a new crystal of the PTFE produced by fiberizing the PTFE. Because the crystal of this new PTFE is a crystal of very large and strong PTFE which melts at around 375° C., the crystal melting heat quantity of this PTFE porous membrane at 360 to 385° C. is 5.0 J/g or more, which is an indicator of a PTFE porous membrane having high tensile strength.

In the PTFE membrane according to the present invention, the temperature is first increased to 400° C. at a rate of 10° C./min (1st. RUN), then cooled to 200° C. at a rate of 10° C./min, after which the temperature is increased a second time to 400° C. at a rate of 10° C./min (2nd. RUN) in order to obtain a DSC curve, and wherein at 290 to 335° C. in the second temperature increase (2nd. RUN) determined using the DSC curve, the heat of fusion (J/g) (H4) of the porous membrane including polytetrafluoroethylene and/or modified polytetrafluoroethylene determined using a differential scanning calorimeter is 20 J/g or less, preferably 18 J/g or less.

It is found that as the H4 decreases, the standard specific gravity (SSG) of the PTFE used in the manufacture of the PTFE porous membrane according to the present invention also decreases, leading to a high molecular weight PTFE. If H4 exceeds 20 J/g, this SSG is large, that is, the molecular weight of the PTFE is low, which is not preferable because it is difficult to obtain the target PTFE porous membrane according to the present invention having a small pore diameter and high strength.

The porosity of the PTFE porous membrane according to the present invention refers to the proportion of the total volume of the pores with respect to the volume of the PTFE porous membrane and can be determined using the Archimedes method, the weight porosity method, or the mercury porosity method. The porosity of the PTFE porous membrane according to the present invention can be determined by determining the density of the PTFE porous membrane according to the present invention in accordance with ASTM D792, which is 70% or more, preferably 75% or more, more preferably 80% or more, and less than 100%. The porosity is preferably high in order to improve the filtration performance and permeability of the liquid of the PTFE porous membrane, wherein it is possible to obtain excellent properties as a porous membrane for filtration of a liquid such as an etching solution of a circuit board in corrosive liquids, organic solvents, or semiconductor manufacturing applications, a porous membrane for gas filtration such as filtration of gas and a vent filter, or a porous membrane as a waterproof sound transmitting porous membrane. Moreover, higher porosity is preferable because the surface density (the weight of the film per unit area) required in the application of waterproof sound transmission decreases.

The film thickness of the PTFE porous membrane according to the present invention is 30 μm or less, preferably 25 μm or less, and more preferably 20 μm or less. While the PTFE porous membrane is preferably a thinner membrane, in general, the thinner membrane results in a decrease in the strength of the PTFE porous membrane, making it easier for problems to occur in the production step. Because the PTFE porous membrane according to the present invention has sufficient strength and can be a thin membrane of 30 μm or less, in addition to having sufficient strength at a film thickness of 10 μm or less and a porosity of 85% or more, a waterproof sound transmitting membrane having a surface density (weight of the membrane per unit area) of approximately 3 g/m² can be produced.

The PTFE used in the manufacture of the PTFE porous membrane according to the present invention preferably has a standard specific gravity (SSG) of 2.15 or less according to ASTM D4895. The SSG is preferably 2.14 or less. It is indicated that SSG correlates with the molecular weight of PTFE, such that as the SSG decreases, the molecular weight of the PTFE increases. In general, as the molecular weight of the PTFE increases, the primary particles of the PTFE are more likely to be fibrilized, making it possible to make a PTFE porous membrane having a smaller pore diameter. Moreover, as the molecular weight of the PTFE increases, the tensile strength also increases.

Note that the PTFE forming the porous membrane may be modified PTFE (that is not melt processible) (modified by a comonomer which is copolymerizable with tetrafluoroethylene (TFE)), or a mixture of PTFE and modified PTFE, as long as the properties of the PTFE are not impaired. Exemplary modified PTFEs include copolymers of TFE (described in Patent Document 4) and a trace amount of monomers other than TFE, with specific examples thereof including a copolymer of tetrafluoroethylene and 0.005 to 1 mol %, preferably 0.01 to 0.1 mol %, and more preferably 0.01 to 0.05 mol % of at least one monomer selected from hexafluoropropylene, perfluoro(alkylvinyl ether), chlorotrifluoroethylene, vinylidene fluoride, vinyl fluoride, and ethylene, wherein the copolymer is not melt processible. The perfluoro(alkyl vinyl ether) is preferably perfluoro(alkyl vinyl ether) having 1 to 6 carbon atoms, more preferably perfluoro(methyl vinyl ether), perfluoro(ethyl vinyl ether), perfluoro(propyl vinyl ether), and perfluoro(butyl vinyl ether). The fluoroalkyl ethylene is preferably a fluoroalkyl ethylene having 1 to 8 carbon atoms, more preferably perfluorobutyl ethylene.

However, some modified PTFEs may have a small SSG despite having a low molecular weight. This is because the SSG is determined in the amount of the specific gravity obtained by temporarily increasing the temperature to the melting temperature or higher, then carrying out cooling and recrystallization. That is, in the case of recrystallization, recrystallization is inhibited due to the presence of a monomer (comonomer) other than a trace amount of TFE, as compared to a polymer of TFE alone, while the crystallinity decreases, leading to a decrease in the value of the specific gravity. Therefore, even if the SSG is 2.15 or less, the molecular weight thereof may be low. In such a resin, the primary particles tend not to be fibrilized, making it impossible to produce porous membranes with small pore diameters.

Therefore, the PTFE used in the manufacture of the PTFE porous membrane according to the present invention is more preferably PTFE which has an SSG of 2.15 or less, has no heating history of 300° C. or higher, and satisfies the abovementioned Equation 2. Regarding the PTFE having an SSG of 2.15 or less and having no heating history of 300° C. or higher, the primary particles are easily fibrilized due to shearing (shear force) when the PTFE is stretched in the extrusion direction, wherein some of the crystals of the primary particles are broken. As the PTFE is more likely to be fibrilized, a PTFE porous membrane having a smaller pore diameter can be made. In contrast, because the heat of fusion of the remaining PTFE primary particles without fibrilization can be determined using a differential scanning calorimeter, the degree of fibrilization of the PTFE can be determined by differences in the crystal melting heat quantity before and after the fibrilization of the PTFE, such that a determination can be made regarding whether a PTFE porous membrane having a small pore diameter can be manufactured.

The H1-H2 represented by the abovementioned Equation 2 is 12 or more. The naphtha used in the H2 determination of Equation 2 is a hydrocarbon based solvent consisting of at least one branched saturated hydrocarbon having 8 to 14 carbon atoms having a boiling point of 150 to 180° C., with examples thereof including Isopar G (available from Exxon Mobil Corporation) (carbon atoms: 9 to 12, boiling point: 160 to 176° C.), Supersol FP25 (available from Idemitsu Kosan Co., Ltd., etc.) (carbon atoms: 11 to 13, boiling point: 150° C. or higher), etc., with Supersol FP25 (available from Idemitsu Kosan Co., Ltd., etc.) preferable in terms of ease of solvent removal from the bead shaped extrudate at H2. Because fibrilization of the PTFE is affected by the type of hydrocarbon based solvent and the addition amount thereof, but is more affected by the addition amount, 28.7 mL of Supersol FP25 available from Idemitsu Kosan Co., Ltd. is preferably added with respect to 100 g of the PTFE.

Moreover, H2 is determined using a molded product obtained by fixing both ends of a bead shaped extrudate with a length of 50 mm and stretching the extrudate 25-fold in the extrusion direction. The bead shaped extrudate can be extruded and molded using a PTFE porous membrane manufacturing apparatus or an extruder capable of molding an extrudate having a diameter of approximately 1 mm, while the bead shaped molded product can be stretched using a stretching apparatus or a tensile tester.

In the stretching method of the present invention, the abovementioned Equation 2 correlates with the bubble point of the PTFE porous membrane with IPA. If the PTFE having a standard specific gravity of 2.15 or less satisfies the abovementioned Equation 2, the obtained PTFE porous membrane has a bubble point of 400 kPa or more with IPA and a pore diameter with excellent tensile strength. Moreover, a porous membrane is used which has a heat of fusion of 5.0 J/g or more at 360 to 385° C., determined using a differential scanning calorimeter (when the temperature is increased to 400° C. at a rate of 10° C./min).

The PTFE used in the manufacture of the PTFE porous membrane according to the present invention can be obtained as PTFE by obtaining an aqueous dispersion containing PTFE primary particles (which is obtained by polymerizing tetrafluoroethylene (TFE) by an emulsion polymerization method in an aqueous medium in the presence of a polymerization initiator (potassium permanganate, oxalic acid), a fluorine-containing surfactant, a polymerization stabilizer (higher paraffin), a succinic acid, and an ionic strength adjusting agent (zinc chloride)) in addition to drying or granulating/drying the aqueous dispersion, wherein the SSG thereof is 2.15 or less and the PTFE satisfies Equation 2. As described above, the PTFE may be modified PTFE (modified by a comonomer which is copolymerizable with tetrafluoroethylene (TFE)), or a mixture of PTFE and modified PTFE as long as it does not impair the properties of the PTFE.

The PTFE porous membrane according to the present invention can be obtained by: adding and mixing a hydrocarbon based solvent having a boiling point of 150 to 290° C. into the abovementioned PTFE; extruding the mixture at an RR of 35 or higher using an extruder; rolling the extrudate in the MD and CD; heating the extrudate to 150° C. or higher in order to evaporate and remove the hydrocarbon based solvent; and thereafter sequentially biaxially stretching the rolled product in the extrusion direction (MD) and the direction (CD) perpendicular to the extrusion direction to obtain a porous membrane; then sintering the porous membrane at a temperature no lower than the melting point of the PTFE. Note that when rolling the extrudate in the MD and CD, the order of rolling in the MD and rolling in the CD may be any order, but each must be carried out at least once together until the extrudate reaches a predetermined thickness.

Exemplary hydrocarbon based solvents used in the manufacture of the PTFE porous membrane according to the present invention include, in addition to naphtha used in the determination of the abovementioned Equation 2, a straight-chain saturated hydrocarbon based solvent and/or branched saturated hydrocarbon based solvent having a boiling point of 150 to 290° C. and having at least one type having 8 to 16 carbon atoms, with exemplary straight-chain saturated hydrocarbon based solvents including Norpar 13 (carbon atoms: 12 to 14, boiling point: 222 to 243° C.) and Norpar 15 (carbon atoms: 9 to 16, boiling point: 255 to 279° C.), with exemplary branched saturated hydrocarbon based solvents including: Isopar G (carbon atoms: 9 to 12, boiling point 160 to 176° C.), Isopar H (carbon atoms: 10 to 13, boiling point 178 to 188° C.), and Isopar M (carbon atoms: 11 to 16, boiling point 223 to 254° C.), each available from Exxon Mobil Corporation; and Supersol FP25 (carbon atoms: 11 to 13, boiling point 150° C. or higher) available from Idemitsu Kosan Co., Ltd.), etc., and with Isomper M preferably used because it prevents the evaporation of the solvent upon rolling, can be easily removed by heating, and is odorless.

The Manufacturing Method is More Specifically as Follows.

Manufacturing Method Step 1. To facilitate extrusion molding, the hydrocarbon based solvent (preferably Isopar M available from Exxon Mobil Corporation) is added to the PTFE in an amount of 20 wt % or less, preferably 18 wt % or less, and more preferably 16 wt % or less, and mixed for 3 to 5 minutes before being left to stand at 20° C. or higher for 12 hours or longer.

Manufacturing Method Step 2. (After obtaining a cylindrical preform at 25° C.±1° C. as needed), using an extruder, extrusion molding is carried out at an RR of 35 to 120, preferably 50 to 120, and more preferably 50 to 80, a molding temperature of 40 to 60° C., preferably 40 to 50° C., and a ram extrusion rate of 10 to 60 mm/min, preferably 20 to 30 mm/min to obtain a sheet shaped extrudate. A bead shaped extrudate can also be obtained instead of a sheet shaped extrudate. When extrusion is carried out in a bead shape, it may be preferable to set the molding temperature to be 5° C. to 10° C. higher than the temperature at which extrusion is carried out in a sheet shape. Even if the rate is the same, this is not particularly problematic. Note that the sheet shaped extrudate and the bead extrudate are hereinafter collectively described as a sheet shaped extrudate.

If the ram extrusion rate is less than 10 mm/min, productivity deteriorates, which is not preferable. If the extrusion rate exceeds 60 mm/min, it is difficult to increase the extrusion pressure or obtain a uniform extrudate, which is not preferable.

If the RR is less than 35, the strength of the extrudate decreases, which is not preferable because the PTFE primary particles are not fibrilized without sufficient shearing (shear force) on the primary particles of the PTFE.

Moreover, as the RR increases, the extrusion pressure during extrusion molding increases. If the RR exceeds 120, a large molding machine is required, which is not preferable.

In addition, if the molding temperature is lower than 40° C., the compatibility between the hydrocarbon based solvent and the PTFE is poor, while fluidity deteriorates, which is not preferable. If the molding temperature exceeds 60° C., the hydrocarbon based solvent evaporates, which is not preferable.

Manufacturing Method Step 3. Using two pairs of rolls, the sheet shaped extrudate is rolled in the two directions of the MD and CD at least once together to obtain a sheet rolled product having a predetermined thickness or less. At this time, in order to set the tensile strength ratio in the MD and CD (after evaporating and removing the hydrocarbon based solvent) to 0.5 to 2.0, each of the rolling ratios in the two directions of the MD and CD are determined while focusing on the relationship between the thickness and the strength of the sheet shaped extrudate. The tensile strength ratio of the obtained sheet shaped rolled product in the MD and CD is preferably 0.5 to 2.0.

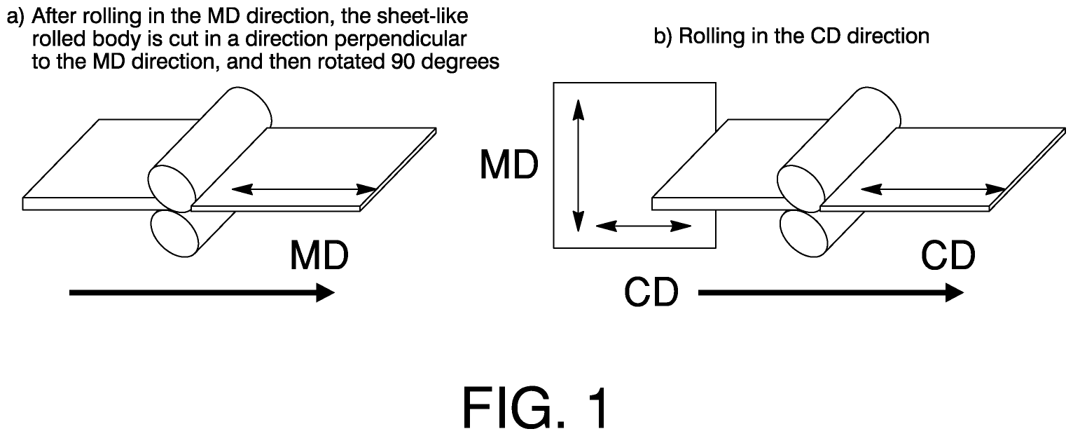

After cutting the extruded sheet to an appropriate length, rolling in the MD is carried out as illustrated in FIG. 1a). As illustrated in FIG. 1b), regarding rolling in the CD, rotation to the MD at 90° C. is followed by unrolling, leading to deformation in the CD. Rolling in these two directions can be used in combination to roll the sheet shaped extrudate to a thickness of 400 μm or less, preferably 300 μm or less, and more preferably 200 μm or less in order to obtain a sheet shaped rolled product.

When the thickness of the sheet shaped rolled product is 400 μm or less, a porous membrane with a thickness of 30 μm or less can ultimately be easily obtained. In general, the thickness of the porous membrane is adjusted with the thickness of the rolling and at the stretching ratio in the MD and CD. However, because the stretching ratio is also a condition which greatly affects the permeability, bubble point, and other characteristics of the porous membrane, it can be readily understood by a person engaged in the manufacture of the porous membrane that the stretching ratio in the MD and CD cannot be altered for thickness adjustment alone. By setting the rolling thickness to 400 μm or less, a membrane with a thickness of 30 μm or less can ultimately be obtained without strictly limiting the stretching conditions in order to achieve a membrane having the target characteristic.

In the present invention, while the order is not limited thereto, a sheet shaped extrudate must be rolled in the MD and CD at least once together. Preferably, a sheet shaped extrudate extruded at an RR of 35 to 120 using an extruder is vertically nipped by two sets of rolls heated to 40° C. or higher as rolling in the MD so as to decrease the thickness thereof, two sets of rolls instead of stretching are then used as rolling in the CD, the sheet is rotated at 90° C., unrolled and nipped from the CD, and deformed in the CD so as to decrease the thickness, and two sets of rolls are used in order to decrease the thicknesses in both the MD and CD.

In general, a PTFE sheet containing a hydrocarbon based solvent (auxiliary agent) tends to have high strength in the direction in which the thickness is reduced by applying an external force regardless of a method such as rolling or stretching. This is a phenomenon which can be easily understood by those engaged in the manufacture of a tape substrate or porous membrane of the PTFE. For example, when the extruded sheet is reduced to half in the MD by two sets of rolls, if there is no deformation in the length in the CD, the sheet is deformed in the MD so as to set the length in the MD approximately two-fold and set the strength therein two-fold. In contrast, when the length is stretched two-fold in the CD, the thickness becomes approximately half, while the strength also becomes two-fold. Therefore, when the thickness in the MD is reduced only by the rolls, a sheet with high MD tensile strength can be obtained, such that the tensile strength ratio in the MD to CD also increases.

Moreover, even if a hydrocarbon based solvent is included and the sheet is stretched in the CD, a sheet with a strong CD tensile strength can be made, with the stretching in the CD also capable of being regarded as rolling in the CD in a broad sense. In the abovementioned Patent Document 5, after the extruded sheet has been stretched 3.7-fold in the direction (CD) perpendicular to the extrusion direction, the extruded sheet is heated to evaporate and remove the hydrocarbon based solvent, then sequentially biaxially stretched in the MD and CD and sintered to produce a PTFE porous membrane having a small difference in the tensile strength between the MD and CD. As an apparatus for carrying out such stretching in the CD, a tenter used for stretching in the CD is preferably used in the case of continuous stretching; however, it is possible to roll the extruded sheet in the MD and continuously roll it using a roll in accordance with the purpose using an apparatus such as that reported in the abovementioned Patent Document 6 as a simpler method.

In the present invention, the ratio (strength ratio) of the tensile strength of the sheet shaped rolled product in the MD and CD after evaporating and removing the hydrocarbon based solvent as described later in 4. is 0.5 to 2.0, preferably 0.5 to 1.8, and more preferably 0.6 to 1.7 in order to determine each rolling ratio in the two directions of the MD and CD. By adding this step, without adjusting the MD/CD stretching ratios in biaxial stretching in the MD and CD as described later in 4., the difference between the tensile strength of the obtained PTFE porous membranes in the MD and CD can be reduced and the strength ratio can be brought close to 1 in order to obtain a PTFE porous membrane having excellent strength. Therefore, in addition to obtaining the effect of preventing the PTFE porous membrane from tearing, the tensile strength itself in the MD and CD can be greatly improved.

The sheet rolled at this strength ratio is more easily sequentially biaxially stretched in the MD and CD as described later in Manufacturing Method Step 4. (compared with a sheet shaped rolled product made with the same thickness only by rolling in the MD), a porous membrane can be produced without tearing even at stretching rates and temperature conditions (in which the PTFE porous membrane generally cannot be made in stretching because of the tearing of the sheet), leading to an increased yield and improved productivity.

Further, because the PTFE porous membrane according to the present invention has a smaller pore diameter of the porous membrane compared to a porous membrane made only by rolling in the MD, a porous membrane with a high bubble point by isopropyl alcohol according to JIS K3832 can be obtained.

Note that if the tensile strength ratio in the MD and CD after evaporating and removing the hydrocarbon based solvent as described later in Manufacturing Method Step 4. is 3 or more, the stretching ratio in the MD and CD is often adjusted so that there is no significant difference in the tensile strength of the obtained porous membrane in the MD and CD. In this case, the tensile strength of the porous membrane itself in the MD and CD is inferior, which is therefore not preferable.

Manufacturing Method Step 4. The hydrocarbon based solvent in the sheet shaped rolled product is evaporated and removed at 150° C. or higher, preferably 200° C. or higher, for 5 minutes or more, preferably 15 minutes or more. Subsequently, using a stretching apparatus, sequential biaxial stretching in the MD and CD is carried out in order to obtain a stretched material (wherein, the molding temperature is 150 to 320° C., preferably 300° C., the strain rate represented by Equation 3 is 20%/sec or higher, preferably 40%/sec or higher), after which the PTFE porous membrane according to the present invention is obtained by sintering (thermal fixing) at a melting point of PTFE or higher, preferably at 350 to 400° C., and more preferably at 370° C. to 385° C. for 10 to 120 seconds.

By rolling the sheet shaped extrudate to 200 μm or less, the hydrocarbon based solvent in the sheet shaped rolled product tends to be evaporated and removed, while a PTFE porous membrane having a thickness of 30 μm or less tends to be molded.

The strain rate when obtaining the stretched material is preferably higher. However, when the strain rate is high, because large equipment is required to ensure the heating time, the strain rate is preferably 130%/sec or lower.

The strain rate represented by Equation 3 of the present invention relates to the rate at the time of deformation and is 20%/sec or more, preferably 30%/sec or more, and more preferably 60%/sec. As the strain rate increases, the bubble point increases, that is, a PTFE porous membrane having a small pore diameter can be obtained. While the strain rate in the extrusion direction (MD) need not be equal to the strain rate in the direction (CD) perpendicular to the extrusion direction (MD), the strain rate in each direction can be determined in accordance with the purpose. The strain rate is particularly effective in stretching in the MD. If the strain rate in stretching in the CD is lower than the strain rate in the MD, a PTFE porous membrane according to the present invention having the target pore diameter can be obtained.

In the stretching step for obtaining the PTFE porous membrane, a discontinuous stretching method is used involving stretching the sheet shaped rolled product discontinuously (to a batch type) using a biaxial stretching machine. In the present invention, the PTFE porous membrane can be obtained by appropriately selecting a stretching method or a stretching apparatus in accordance with the target properties of the PTFE porous membrane.

The stretching ratio in the MD and CD is 5-fold or higher, preferably 7-fold or higher, and more preferably 10-fold or higher. In addition, while it is not necessary to set the stretching ratio in the MD and CD to the same ratio, the stretching ratio in each direction can be determined in accordance with the purpose. Depending on the thickness after rolling, the stretching ratio in the extrusion direction is preferably 7-fold or higher because the thickness of the PTFE porous membrane is more likely to be 30 μm or less.

In the continuous stretching method, first, the sheet shaped rolled product is continuously stretched in the same direction as the extrusion direction (MD) of the sheet shaped rolled product using a longitudinal (extrusion direction) stretching apparatus having multiple rolls (nip rolls) capable of heating and vertically nipping (pinching). In the case of continuous stretching in the extrusion direction (MD) using multiple sets of rolls, the rate ratio is preferably set to the rotation rate of each set of rollers. For example, in FIG. 1a), it is preferable to allow the rotation rate of the pair of rollers on the outlet side to be faster than the roll rotation rate of the pair of rollers on the inlet side because this allows for larger stretching (stretching at a high ratio of 10-fold or more). While not limited thereto, the diameter of the rolls is generally approximately 200 mm.

Moreover, a method of continuously stretching in the extrusion direction (MD) (using an apparatus having a heating zone between each set of rolls, for example, an apparatus having the heating furnace illustrated in FIG. 1a) is also suitably used.

Using an extrusion direction (MD) stretching apparatus having two sets of rolls (nip rolls) capable of nipping (pinching) illustrated in FIG. 1a), if Vex in Equation 3 is 500 mm/sec, Vin therein is 100 mm/sec, and L therein is 1000 mm (that is, the distance between two sets of rolls is 1000 mm), the strain rate is 40%/sec (((500-100)/1000)×100=40).

Next, a tenter continuously stretchable in the direction (CD) perpendicular to the extrusion direction is used to continuously grip both sides of the sheet shaped stretched material (continuously stretched in the extrusion direction (MD)) with a chuck, move the chuck while heating, and continuously extend the stretched material in the direction (CD) perpendicular to the extrusion direction to obtain a PTFE porous membrane.

In the discontinuous stretching method, the sheet shaped rolled product is cut into a predetermined shape and size, four corners or the periphery of the cut sheet shaped rolled product are fixed by chucks using a biaxial stretching machine, and the chucks are sequentially stretched in the MD and CD (FIG. 2b). This batch type is repeated to discontinuously obtain a PTFE porous membrane.

In the discontinuous stretching method, (Vex-Vin) is defined as the stretching rate (rate at which the chuck is moved) in Equation 3. L (inter-stretching distance) is the value obtained by subtracting the size of the pre-stretched sheet shaped rolled object from the size of the stretched sheet material. For example, when the stretching rate in the MD is 400 mm/sec and L is 400 mm (that is, when the size of the PTFE sheet before stretching is 100 mm square and extends to 500 mm square, L is 400 mm), the strain rate is 100%/sec ((400/(500-100))×100=100).

### EXAMPLES

While not strictly limited to the examples, the present invention will be hereinafter described further specifically using these examples.

### Standard Specific Gravity (SSG)

The standard specific gravity of the PTFE was determined according to ASTM D4895.

### Bubble Point

The bubble point with isopropyl alcohol (IPA) was determined in accordance with JIS K3832 using Pololax1000 available from MicrotracBEL Corp.

### Tensile Strength and Permeability

Using a porous membrane sample piece (MD stretching direction: 50 mm, CD stretching direction: 10 mm) made from a PTFE porous membrane obtained under the conditions indicated in Table 1, the tensile strength was determined in accordance with JIS K6251 using a Tensilon RTC1310A (available from Orientec Co., Ltd.) at 25° C., a chuck interval of 22 mm, and a tensile rate of 200 mm/min, while the permeability was determined using a Frazier type tester.

### Porosity

The true density of the PTFE (2.2 g/cm³) and the density of the PTFE porous membrane according to the present invention determined in accordance with ASTM D792 was used to determine the porosity of the PTFE porous membrane based on the following formula.

Porosity (%)=(1−(density of the PTFE porous membrane/true density of the PTFE in the PTFE porous membrane))×100 (film thickness)

A dial thickness gauge available from Peacock was used for determination.

### Heat of Fusion

1. The heat of fusion (J/g) of the abovementioned H1 was determined using a differential scanning calorimeter (Diamond DSC available from PerkinElmer Co., Ltd.) from a DSC curve obtained by increasing the temperature of 10 mg of PTFE (having no heating history of 300° C. or higher) to 400° C. at a rate of 10° C./min.
2. The heat of fusion at 300 to 360° C. (J/g) was determined as in the abovementioned 1 except that the heat of fusion of the abovementioned H2 was determined using 10 mg of the below-mentioned sample for H2 determination.

### Sample for H2 Determination

To 100 g of PTFE which had no heating history of 300° C. or higher, 28.7 ml of a naphtha (Supersol FP25 available from Idemitsu Kosan Co., Ltd.) having a boiling point of 150 to 180° C. was added and mixed for 3 minutes and left to stand at 25° C. for 2 hours, then using an extruder, extruded and formed at a ratio (RR) of the cylinder cross sectional area/outlet cross sectional area of 100, a molding temperature of 25° C.±1° C., and a ram extrusion rate of 0.5 m/min to obtain a bead shaped extrudate, which was subsequently dried at 25±1° C. for 1.5 hours, and further at 150° C. for 2 hours, and (after the naphtha was evaporated and removed) cut to a length of 51 mm to fix both ends, stretched 25-fold in the extrusion direction at a molding temperature of 300° C. and a strain rate of 100%/sec (stretching rate 100%/sec) to obtain a molded product, which was used as a sample for H2 determination.
3. The heat of fusion of the PTFE porous membrane was determined using a differential scanning calorimeter, wherein, regarding 10 mg of the PTFE porous membrane obtained under the conditions indicated in Table 1, the temperature was first increased to 400° C. at a rate of 10° C./min (1st. RUN), then cooled to 200° C. at a rate of 10° C./min, after which the temperature is increased a second time to 400° C. at 10° C./min (2nd. RUN) in order to obtain a DSC curve, wherein the temperature was first increased (1st. RUN) to determine the heat of fusion (J/g) at 300 to 360° C. as H3 when using the DSC curve, while the temperature was increased a second time (2nd. RUN) to determine the crystal melting heat quantity (J/g) at 290 to 335° C. as H4 when using the DSC curve.

### Structure of the PTFE Porous Membrane

Following the sputter deposition of the PTFE porous membrane with platinum palladium alloy, it was observed under an electron microscope (SU-8000 available from Hitachi High-Tech Corporation).

### PTFE

60 g paraffin wax, 2300 ml deionized water, and 12 g ammonium salt of a fluoromonoether acid (formula: C₃F₇—O—CF(CF₃)COOH), 0.05 g ammonium salt of fluoropolyether acid (C₃F₇—O—[CF(CF₃)CF₂]ₙ—CF(CF₃)COOH), 0.75 g succinic acid, 0.026 g oxalic acid, and 0.01 g zinc chloride were placed in an autoclave (having a content of 4 liters) made of stainless steel (SUS316) provided with a stirring blade and a jacket for temperature adjustment, after which, while heated to 80° C., the inside of the system was purged with nitrogen gas three times to remove the oxygen, before evacuating by vacuum. Thereafter, the internal temperature was maintained at 63° C. while stirring at 111 rpm with an internal pressure of 2.75 MPa using tetrafluoroethylene (TFE).

Next, added was 510 ml of an aqueous solution in which 40 mg of potassium permanganate (KMnO₄) was dissolved in 2000 ml of water. At the end of the injection of potassium permanganate, the internal temperature was increased to 85° C., after which TFE was supplied thereto. Stirring was stopped when the consumption of TFE reached 740 g. The gas in the autoclave was released to atmospheric pressure, the vacuum was evacuated, the pressure was returned to atmospheric pressure with nitrogen gas, and the contents were removed to complete the reaction.

The solid content of the obtained PTFE dispersion was 27%, while the average particle diameter of the primary particles was 0.23 μm. This PTFE dispersion was dried at 190° C. for 11 hours to obtain PTFE fine powder. The standard specific gravity (SSG) of the obtained PTFE fine powder and the crystal melting heat quantity (H1, H2, and H1-H2) thereof are indicated in Table 1.

### Examples 1 to 4

Using the PTFE fine powder, Isopar M available from Exxon Mobil Corporation in addition to the amounts indicated in Table 2, was mixed for five minutes using a Turbula shaker available from Willy A. Bachofen AG, left to stand at 25° C. for 24 hours, then placed in a cylinder having a diameter of 80 mm of a preforming machine. Subsequently, the upper part of the cylinder was covered with a lid, after which the cylinder was compression molded at room temperature (approximately 15 to 30° C.) at a rate of 50 mm/min to obtain a cylindrical preform. The obtained preform was extruded and molded using an extruder at an RR of 36, a molding temperature of 50° C., and an extrusion rate of 20 mm/min, then extruded using an extrusion die (thickness: 1 mm×width: 140 mm) to obtain a sheet shaped extrudate. The obtained sheet shaped extrudate was cut to a length of 120 mm and rolled multiple times in the extrusion direction (MD) and the direction (CD) perpendicular to the extrusion direction using two sets of rolls heated to 50° C. until reaching the thickness after rolling indicated in Table 2. Thereafter, the abovementioned Isopar M was evaporated and removed at 200° C. for 15 minutes to obtain a sheet shaped rolled product, which was then cut into a square (90 mm square). The ratio (MD/CD strength ratio) of the tensile strength of the sheet shaped rolled product in the extrusion direction (MD) to the direction (CD) perpendicular to the extrusion direction is indicated in Table 2.

Using a biaxial stretching apparatus (EX10-S5 type, available from Toyo Seiki Seisaku-sho, Ltd.), the periphery of the square (90 mm square) rolled product was fixed by a chuck (size: 72 mm angle excluding the chuck grip of the biaxial stretching apparatus), sequentially stretched 10-fold in the MD and CD at a molding temperature of 300° C. at the stretching rate (rate at which the chuck was moved) and strain rate indicated in Table 2 to obtain the stretched material (size: 720 mm angle excluding the chuck grip of the biaxial stretching apparatus) (batch type). Two plates heated to 370° C. were held for 10 seconds at a distance of 5 mm above and below from the stretched material, which was then sintered, after which the surrounding chucks were removed to obtain a PTFE porous membrane.

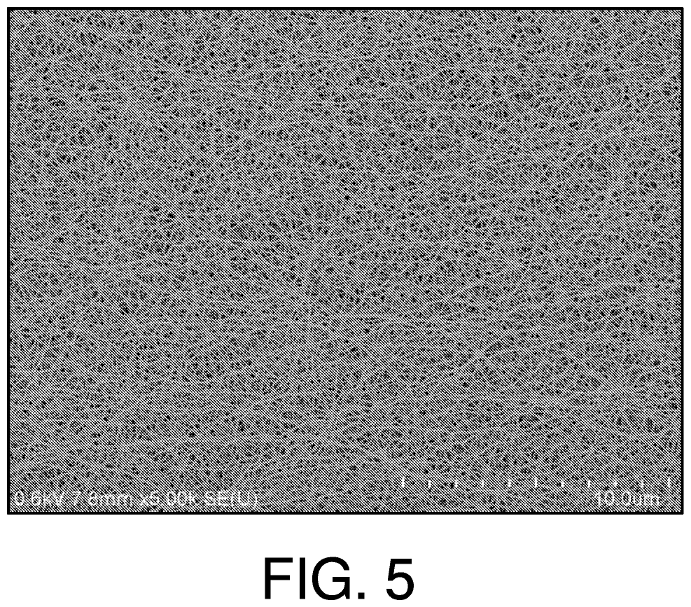

The bubble point of the obtained PTFE porous membrane, the tensile strength thereof (in the MD and CD), the MD/CD strength ratio thereof, the porosity thereof, the film thickness thereof, the permeability thereof, the heat of fusion (H3 and H4) of the PTFE porous membrane, and the degree of sintering thereof are indicated in Table 2. The DSC curve of the PTFE porous membrane obtained in Example 1 is illustrated in FIG. 3, while the electron microphotograph is illustrated in FIG. 5.

### Comparative Example 1

An attempt was made to produce a PTFE porous membrane as in Example 1, except that rolling in the CD was not carried out, with only rolling in the MD carried out. However, when stretching, the sheet shaped rolled product after evaporating and removing the hydrocarbon based solvent was torn, leading to a failure to produce the porous membrane. The results are shown in Table 1.

### Comparative Example 2

A PTFE porous membrane was produced as in Example 2, except that rolling in the CD was not carried out, with only rolling in the MD carried out. The MD/CD strength ratio of the sheet, the bubble point of the obtained PTFE porous membrane, the tensile strength thereof (in the MD and CD), the MD/CD strength ratio thereof, the porosity thereof, the film thickness thereof, the permeability thereof, the heat of fusion (H3 and H4) of the PTFE porous membrane, and the degree of sintering thereof are indicated in Table 1.

### Comparative Example 3

A PTFE porous membrane was produced as in Comparative Example 2, except that using a biaxial stretching apparatus, the stretching ratio in the MD was 7.5-fold, while the stretching ratio in the CD was 10-fold. This sheet was a sheet shaped rolled product having a MD/CD strength ratio of 6.5 as well as high tensile strength in the MD. Stretching was carried out at a stretching ratio of 7.5-fold in the MD and a stretching ratio of 10-fold in the CD such that the MD/CD strength ratio of the PTFE porous membrane obtained by stretching the sheet shaped rolled product was 0.5 to 2.0. The bubble point of the obtained PTFE porous membrane, the tensile strength thereof (in the MD and CD), the MD/CD strength ratio thereof, the porosity thereof, the film thickness thereof, the permeability thereof, the heat of fusion (H3 and H4) of the PTFE porous membrane, and the degree of sintering thereof are indicated in Table 1.

### Comparative Example 4

A porous membrane was produced as in Comparative Example 2, except that rolling in the CD was not carried out, with rolling in the MD carried out to give 400 μm, and the strain speed represented is 144 mm/sec. The film thickness of the obtained film was 22.8 μm.

### Comparative Example 5

A porous membrane was produced as in Comparative Example 4, except that the strain speed represented is 1288 mm/sec. The film thickness of the obtained film was 21.8 μm.

TABLE 1

| | | | Ex. 1 | Comp. Ex. 1 |
|---|---|---|---|---|
| PTFE porous | PTFE specific gravity (SS6) | — | 2.14 | 2.14 |
| membrane | Hydrocarbon based solvent | wt % | 14 | 14 |
| manufacturing | (Isopar M) | | | |
| conditions | Thickness after rolling in | μm | 400 | 200 |
| | the MD | | | |
| | Thickness after rolling in | μm | 200 | — |
| | the CD | | | (without rolling |
| | | | | in the CD) |
| | Tensile strength in the MD | MPa | 15.8 | 23.1 |
| | Tensile strength in the CD | MPa | 9.3 | 3.2 |
| | Strength ratio of the sheet | — | 1.7 | 7.2 |
| | shaped rolled product in | | | |
| | the MD/CD | | | |
| | Stretching ratio | — | Vertical: 10/ | Vertical: 10/ |
| | | | lateral: 10 | lateral: 10 |
| | Stretching rate | Mm/sec | 290 | 290 |
| | Inter-stretching distance | mm | Vertical: 648/ | Unstretched |
| | | | lateral: 648 | tear generation |
| | MD strain rate (stretching | %/sec | 40 | |
| | rate/inter-stretching | | | |
| | distance × 100 | | | |
| | Sintering temperature | ° C. | 370 | |
| | Sintering time | sec | 10 | |
| Physical | Bubble point | kPa | 804 | — |
| properties of | Tensile strength in the MD | MPa | 104 | — |
| the PTFE | Tensile strength in the CD | MPa | 90 | — |
| porous | Strength ratio in the MD/CD | — | 1.16 | — |
| membrane | Porosity | % | 75 | — |
| | Film thickness | Mm | 4.0 | — |
| | Permeability | cm³/s/cm³ | 0.1 | — |

TABLE 2

| | | | | | | Comp. | Comp. | Comp | Comp |
|---|---|---|---|---|---|---|---|---|---|
| | | | Ex. 2 | Ex. 3 | Ex.4 | Ex.2 | Ex. 3 | Ex.4 | Ex. 5 |
| PTFE | PTFE | — | 2.14 | | | 2.14 | | | |
| porous | specific | | | | | | | | |
| membrane | gravity (SS6) | | | | | | | | |
| manufacturing | Hydrocarbon | wt % | 20 | 20 | 14 | 20 | 20 | 20 | 20 |
| conditions | based | | | | | | | | |
| | solvent | | | | | | | | |
| | (Isopar M) | | | | | | | | |
| | Thickness | μm | 400 | 400 | 600/ | 200 | 200 | 400 | 400 |
| | after rolling in | | | | 200 | | | | |
| | the MD | | | | | | | | |
| | Thickness | μm | 200 | 100 | 800/ | — | — | — | — |
| | after rolling in | | | | 400 | (without | (without | (without | (without |
| | the CD | | | | | rolling | rolling | rolling | rolling |
| | | | | | | in the CD) | in the CD) | in the CD) | in the CD) |
| | Tensile | MPa | 10.2 | 8.2 | 20.4 | 16.1 | 16.1 | 9.4 | 9.4 |
| | strength in | | | | | | | | |
| | the MD | | | | | | | | |
| | Tensile | MPa | 6.8 | 13.5 | 12.2 | 2.5 | 2.5 | 3.2 | 3.2 |
| | strength in | | | | | | | | |
| | the CD | | | | | | | | |
| | Strength ratio | — | 1.2 | 0.6 | 1.7 | 6.5 | 6.5 | 3.0 | 3.0 |
| | of the sheet | | | | | | | | |
| | shaped rolled | | | | | | | | |
| | product in | | | | | | | | |
| | the MD/CD | | | | | | | | |
| | Stretching | — | Vertical: 10/ | | | Vertical: 10/ | Vertical: 7.5/ | Vertical: 10 / | |
| | ratio | | lateral: 10 | | | lateral: 10 | lateral: 10 | lateral: 10 | |
| | Stretching | Mm/ | 720 | 720 | 290 | 720 | 720 | 144 | 288 |
| | rate | sec | | | | | | | |
| | Inter- | mm | Vertical: 648/ | | | Vertical: 648/ | Vertical: 468/ | Vertical: 648 / | |
| | stretching | | lateral: 648 | | | lateral: 648 | lateral: 648 | lateral: 648 | |
| | distance | | | | | | | | |
| | MD strain | %/sec | 111 | 111 | 40 | 111 | Vertical: 154/ | 22 | 44 |
| | rate | | | | | | lateral: 111 | | |
| | (stretching | | | | | | | | |
| | rate/inter- | | | | | | | | |
| | stretching | | | | | | | | |
| | distance × | | | | | | | | |
| | 100 | | | | | | | | |
| | Sintering | ° C. | 370 | | | 370 | | | |
| | temperature | | | | | | | | |
| | Sintering | sec | 10 | | | 10 | | | |
| | time | | | | | | | | |
| Physical | Bubble point | kPa | 610 | 600 | 705 | 419 | 380 | 314 | 340 |
| properties | Tensile | MPa | 95 | 121 | 147 | 59.6 | 65 | 46 | 52.2 |
| of the PTFE | strength in | | | | | | | | |
| porous | the MD | | | | | | | | |
| membrane | Tensile | MPa | 90 | 162 | 131 | 19.9 | 37 | 24.3 | 23.8 |
| | strength in | | | | | | | | |
| | the CD | | | | | | | | |
| | Strength ratio | — | 1.06 | 0.75 | 1.12 | 2.99 | 1.70 | 1.89 | 2.19 |
| | in the MD/CD | | | | | | | | |
| | Porosity | % | 84 | 79 | 70 | 78 | 84 | 83 | 85 |
| | Film | Mm | 4.0 | 2.0 | 6.0 | 6.8 | 10.0 | 22.8 | 21.8 |
| | thickness | | | | | | | | |
| | Permeability | cm³/ | 0.3 | 0.4 | 0.13 | 0.24 | 0.30 | 0.32 | 0.24 |
| | | s/cm³ | | | | | | | |
| Heat of | PTFE | | | | | | | | |
| fusion | 1st. RUN: | J/g | 68.1 | | | 68.1 | | | |
| | 300 to | | | | | | | | |
| | 360° C. | | | | | | | | |
| | (H1) | | | | | | | | |
| | 1st. RUN: | J/g | 55.2 | | | 55.2 | | | |
| | 300 to | | | | | | | | |
| | 360° C. | | | | | | | | |
| | (H2) | | | | | | | | |
| | H1 − H2 | J/g | 12.9 | | | 12.9 | | | |
| | PTFE porous | | | | | | | | |
| | membrane | | | | | | | | |
| | 1st. RUN: | J/g | 21.2 | 19.5 | 19.1 | 19.8 | 19.9 | 14.9 | 15.8 |
| | 300 to | | | | | | | | |
| | 360° C. | | | | | | | | |
| | (H3) | | | | | | | | |
| | 1st. RUN: | J/g | 5.0 | 5.2 | 7.4 | 5.4 | 5.1 | 4.5 | 4.3 |
| | 360 to | | | | | | | | |
| | 385° C. | | | | | | | | |
| | 2nd. RUN: | J/g | 12.0 | 11.6 | 9.9 | 11.8 | 11.6 | 12.5 | 12.2 |
| | 290 to | | | | | | | | |
| | 335° C. | | | | | | | | |
| | (H4) | | | | | | | | |
| Sintering | H1 − H3/ | — | 0.84 | 0.86 | 0.84 | 0.86 | 0.85 | 0.96 | 0.94 |
| degree | H1 − H4 | | | | | | | | |

### INDUSTRIAL APPLICABILITY

The present invention provides: a porous membrane including polytetrafluoroethylene and/or modified polytetrafluoroethylene having a small pore diameter, thin film thickness, high porosity, and high strength, along with a small difference in the tensile strength between the MD and CD; and a method for manufacturing the same.

The present invention can be suitably used in waterproof sound transmitting applications for communication apparatuses, automotive vent filters which require high water resistance, dust proofing applications such as dust collecting bag filters and air filters, and filtration applications such as etching solutions of circuit boards in corrosive liquids, organic solvents, or semiconductor manufacturing applications, as well as applications such as the collection of valuable substances in etching solutions.

1. A porous membrane comprising polytetrafluoroethylene and/or modified polytetrafluoroethylene, wherein the bubble point of isopropyl alcohol according to JIS K3832 is 600 kPa or more, the tensile strength in the extrusion direction (MD) according to JIS K6251 is 90 MPa or more, and the tensile strength ratio in the extrusion direction (MD) to the direction (CD) perpendicular to the extrusion direction is 0.5 to 2.0.

2. The porous membrane according to claim 1, wherein the heat of fusion of the porous membrane comprising polytetrafluoroethylene and/or modified polytetrafluoroethylene determined by differential scanning calorimetry over the temperature range of 360 to 385° C. when the temperature is increased at a rate of 10° C./min is 5.0 J/g or more.

3. The porous membrane according to claim 2, wherein a heat of fusion of said porous membrane is determined by the following procedure:
i) the temperature is first increased to 400° C. at a rate of 10° C./min (1st. RUN),
ii) then cooled to 200° C. at a rate of 10° C./min, after which
iii) the temperature is increased a second time to 400° C. at a rate of 10° C./min (2nd. RUN) in order to obtain a differential scanning calorimetry curve,
and wherein the heat of fusion is determined by differential scanning calorimetry over the temperature range of 290 to 335° C. from the second temperature increase (2nd. RUN), and wherein the heat of fusion (J/g) of the porous membrane comprising polytetrafluoroethylene and/or modified polytetrafluoroethylene is 20 J/g or less.

4. The porous membrane according to claim 1, wherein the degree of sintering (S) of the porous membrane represented by the formula: degree of sintering (S)=(H1-H3)/(H1-H4), is 0.9 or more, wherein:
H1 is the heat of fusion (J/g) of the polytetrafluoroethylene and/or modified polytetrafluoroethylene having no heating history at 300° C. and higher used to make the porous membrane, measured from a differential scanning calorimetry curve obtained over a temperature range of 300 to 360° C. using a differential scanning calorimeter, wherein the sample temperature is increased to 400° C. at a rate of 10° C./min,
H3 is the heat of fusion (J/g) of the polytetrafluoroethylene and/or modified polytetrafluoroethylene porous membrane for the first melt (1st RUN), measured from a differential scanning calorimetry curve over a temperature range of 300 to 360° C. using a differential scanning calorimeter, wherein the sample temperature is increased to 400° C. at a rate of 10° C./min, and
H4 is the heat of fusion (J/g) of the polytetrafluoroethylene and/or modified polytetrafluoroethylene porous membrane for the second melt (2nd RUN), measured from a differential scanning calorimetry curve over a temperature range of 290 to 335° C. using a differential scanning calorimeter, wherein the sample temperature is increased to 400° C. at a rate of 10° C./min (first melt), then the sample is cooled to 200° C. at a rate of 10° C./min, then the sample temperature is increased to 400° C. at a rate of 10° C./min (second melt) to generate the differential scanning calorimetry curve from which H4 is determined.

5. The porous membrane according to claim 1, wherein the porosity is 70% or more.

6. The porous membrane according to claim 1, wherein the film thickness of the porous membrane is 30 μm or less.

7. The porous membrane according to claim 1, wherein polytetrafluoroethylene used in the manufacture of the porous membrane comprising polytetrafluoroethylene and/or modified polytetrafluoroethylene is polytetrafluoroethylene having a standard specific gravity of 2.15 or less and satisfying the formula H1-H2>12, wherein:
H1 is the heat of fusion (J/g) of the polytetrafluoroethylene and/or modified polytetrafluoroethylene having no heating history at 300° C. and higher used to make the porous membrane, measured from a differential scanning calorimetry curve obtained over a temperature range of 300 to 360° C. using a differential scanning calorimeter, wherein the sample temperature is increased to 400° C. at a rate of 10° C./min, and
H2 is the heat of fusion (J/g) of the polytetrafluoroethylene and/or modified polytetrafluoroethylene formed into a stretched membrane product, the polytetrafluoroethylene and/or modified polytetrafluoroethylene having no heating history at 300° C. and higher, and
wherein H2 is measured from a differential scanning calorimetry curve over a temperature range of 300 to 360° C. using a differential scanning calorimeter, wherein the sample temperature is increased to 400° C. at a rate of 10° C./min, and
wherein the formed stretched membrane product is obtained by mixing 100 g of polytetrafluoroethylene and/or modified polytetrafluoroethylene with about 28.7 ml of naptha having a boiling point of about 150-180° C. for about 3 minutes and then left to stand at about 25° C. for about 2 hours, and then using an extruder to ram extrude a bead-shaped extrudate from the fluoropolymer and naptha mixture, the extrudate being formed at a ratio (RR) of the extruder cylinder cross sectional area to outlet cross sectional area of about 100 and a ram extrusion rate of about 0.5 m/min, and a temperature of about 25° C., resulting in formation of the bead-shaped extrudate, which is then dried at about 25° C. for about 1.5 hours and then dried further at about 150° C. for about 2 hours, following which the dried bead shaped extrudate is then stretched 25-fold in the extrusion direction at a temperature of about 300° C. and a stretching rate of about 100%/second and then cooled to room temperature resulting in the formed and stretched membrane product.

8. The porous membrane according to claim 1, wherein the modified polytetrafluoroethylene used in the manufacture of the porous membrane comprising polytetrafluoroethylene and/or modified polytetrafluoroethylene is a copolymer comprising: tetrafluoroethylene; and 0.005 to 1 mol % of at least one monomer selected from hexafluoropropylene, perfluoro(alkylvinyl ether), fluoroalkyl ethylene, chlorotrifluoroethylene, vinylidene fluoride, vinyl fluoride, and ethylene.

9. A method for manufacturing a porous membrane comprising polytetrafluoroethylene and/or modified polytetrafluoroethylene, the method comprising: adding and mixing a hydrocarbon based solvent having a boiling point of 150 to 290° C. into the polytetrafluoroethylene and/or modified polytetrafluoroethylene according to claim 8; extruding the mixture at an RR of 35 to 120 using an extruder to obtain a sheet shaped or bead shaped extrudate; rolling the extrudate in the extrusion direction (MD) and the direction (CD) perpendicular to the extrusion direction at least once together so as to obtain a rolled product having a thickness of 400 μm or less; heating the rolled product to 150° C. or higher in order to evaporate and remove the hydrocarbon based solvent; and thereafter sequentially biaxially stretching the rolled product in the MD and CD to obtain a porous membrane; then sintering the porous membrane at a temperature no lower than the melting point of polytetrafluoroethylene.

10. The method for manufacturing a porous membrane according to claim 9, wherein the tensile strength ratio of the rolled product from the sheet shaped or bead shaped extrudate in the MD to the CD is 0.5 to 2.0.

11. The method for manufacturing a porous membrane according to claim 9, wherein the rolled product is sequentially biaxially stretched five-fold or higher in the MD and five-fold or higher in the CD such that the strain rate represented by the formula: strain rate (%/sec)=((Vex-Vin)/L)×100, in the MD is 20%/sec or higher, wherein:
a) In the case of continuous stretching:
Vex is the rate (mm/sec) of the outlet of the vertical (extrusion direction) stretching apparatus,
Vin is the rate (mm/sec) of the inlet of the vertical (extrusion direction) stretching apparatus, and
L is the inter-stretching distance (mm) (distance between two sets of rolls), and
b) in the case of non-continuous stretching:
(Vex-Vin) is the stretching rate (mm/sec) of the biaxial stretching apparatus, and
L is the inter-stretching distance (mm), which is the value obtained by subtracting the size of the pre-stretched sheet shaped rolled product from the size of the stretched sheet material.
